(19) United States
(12) Patent Application Publication
(10) Pub. No.: US 2022/0204066 A1
(43) Pub. Date: Jun. 30, 2022

(54) SYSTEM AND METHOD FOR OPERATION OF COLLAPSIBLE MULTI-SHELF CARTS

(71) Applicant: Advanced Intelligent Systems Inc., Burnaby (CA)

(72) Inventor: Farhang Bidram, Burnaby (CA)

(21) Appl. No.: 17/605,924

(22) PCT Filed: Apr. 28, 2020
(86) PCT No.: PCT/CA2020/050556

§ 371 Date: Oct. 22, 2021

Related U.S. Application Data
(60) Provisional application No. 62/840,350, filed on Apr. 29, 2019.

(51) Int. Cl. B62B 5/00; A47B 57/06; A47B 91/00; B25J 5/00; B62B 3/00; B25J 9/16

(52) U.S. Cl. CPC B62B 5/0079; A47B 57/06; A47B 91/002; B25J 5/007; B62B 2207/00; B25J 9/1679; B25J 9/162; B62B 2202/70; B62B 2203/10; B62B 3/005

(57) ABSTRACT

A multi-shelf storage apparatus for storage of articles, comprising a wheeled base; a frame disposed on the wheeled base; a plurality of vertically-spaced shelves on the frame for providing a storage area for articles, each shelf configured to move vertically. The apparatus includes a lift mechanism disposed on the frame, coupled to the shelves, and configured to cause collapse and extension of the shelves in a vertical direction. The apparatus has an actuator on the frame operable to drive the lift mechanism, and a power interface on the frame and electrically connected to the actuator. The apparatus has a mechanical connection for connecting to a towing device and a first power interface integral to the mechanical connection such that the actuator can receive electrical power from the towing device. Systems comprising one or more of the apparatuses and methods for loading/unloading articles utilizing the apparatuses are also disclosed.

### TECHNICAL FIELD

The subject matter disclosed herein relates to the technical field of article transportation and storage, and more particularly to article loading and unloading to and from a multi-shelf storage unit with adjustable heights.

### BACKGROUND

The current invention provides a system to manage article transportation and storage by providing a multi-shelf storage unit (for such articles) that has height adjustable trays to facilitate article loading and unloading to and from the unit's trays. Development of such multi-shelf storage units could facilitate automatic loading and unloading of articles to and from the storage unit by bringing elevated shelves to the accessible region of a loader/unloader unit rather than having to increase the accessibility region of the loader/unloader unit to cover elevated shelves. In other words, the automatic loader/unloader unit, such as robots or robotic lift trucks, are not required to be tall or elevated; instead, the elevated shelves could be lowered to be within the accessibility region of a typical, short loader/unloader unit so as to be reachable thereto. Moreover, loading/unloading to and from higher shelves and working in higher elevations is always a safety concern. Hence, the proposed system could be used to reduce the complexity of the loading/unloading robotic systems and increase the safety of material handling as well.

The application of such invention could be envisaged, for example, in inventory management, warehousing, transportation of medical items, and transportation of potted plants in plant nurseries. In a warehouse, the proposed invention could be an alternative solution to the cartesian, aisle, and shuttle robotic systems for which large and expensive infrastructures and equipment may otherwise be required.

### SUMMARY

In accordance with one disclosed aspect, there is provided a multi-shelf storage apparatus for storage of a plurality of articles. The apparatus includes a wheeled base, a frame disposed on the wheeled base, a plurality of generally vertically spaced shelves disposed on the frame, operably configured to provide a storage area for articles, each shelf configured to be able to move in a generally vertical direction relative to the frame. The apparatus also includes a lift mechanism disposed on the frame and coupled to the plurality of the shelves, the lift mechanism configured to cause collapse and extension of the shelves in generally a vertical direction. The apparatus further includes an actuator disposed on the frame operably configured to drive the lift mechanism, and at least one power interface disposed on the frame and electrically connected to the actuator. The apparatus may include a first mechanical connection for connecting the apparatus to a towing device and a first power interface of the at least one power interface, wherein the first power interface is integral to the first mechanical connection such that the actuator receives electrical power from the towing device.

The apparatus may then further include a second power interface and a second mechanical connection for connecting the apparatus to a subsequent apparatus, wherein the second power interface is integral to the second mechanical connection such that an actuator of the subsequent apparatus receives power from the apparatus. The first mechanical connection may be a passive mechanical connection configured to receive a complementary mechanical connection, and the second mechanical connection may be configured to engage with a complementary mechanical connection of the subsequent apparatus. The second mechanical connection may include a connection actuator operable to engage or disengage with the complementary mechanical connection of the subsequent apparatus. The connection actuator may be electrically connected to the power interface such that the connection actuator receives electrical power from the towing device.

The power interface may include an alignment device configured to facilitate receiving a power supply interface of an autonomous power supplying mobile robotic unit. The apparatus may also include a controller disposed on the frame, the controller including at least a processing unit, a memory, and a power supply; the controller is configured to control operation of the actuator or connection actuator. The controller may further include a localization system comprising one or more sensors or transceivers configured to facilitate locating the apparatus. The controller may also include a communication system configured to send or receive at least a signal. The controller may additionally include a monitoring system comprising one or more sensors configured to monitor a status of the apparatus.

In accordance with another disclosed aspect there is provided a system for transporting a plurality of articles. The system includes one or more or the multi-shelf storage apparatuses mentioned above, and a towing device configured to move the one or more apparatuses through a mechanical connection, where the towing device connects to a first apparatus of the one or more apparatuses through the first mechanical connection and supplies power to the first apparatus. The system may also include a second apparatus of the one or more apparatuses which is attached to the first apparatus through the second mechanical connection such that the first apparatus supplies power to the second apparatus.

In accordance with yet another disclosed aspect there is provided a system for transporting a plurality of articles. The system includes one or more of the multi-shelf storage apparatuses mentioned above, and a robotic unit configured to automatically load or unload a plurality of articles to or from the multi-shelf storage unit. The robotic unit includes a base comprising a plurality of powered wheels, at least one robotic manipulator disposed on the base, a loading or unloading end effector operably disposed on the at least one robotic manipulator and configured to engage with articles to load or unload articles to and from the multi-shelf storage unit, and a power supply interface complementary to the power interface of the apparatus to drive the actuator of the apparatus to raise and lower shelves.

The system may also include a controller disposed on at least one of the towing device, the robotic unit or the apparatuses, the controller configured to control operation of at least one of the actuators or the connection actuators. The controller may cause at least one of the connection actuators to automatically disconnect one or more subsequent apparatuses from the one or more apparatuses. The system may also include a cloud server, the cloud server configured to communicate with at least one of the controller, the towing device, or the robotic unit. The towing device may send information to the cloud server regarding the location of the one or more apparatuses. The robotic unit may be configured to monitor a status of the apparatus and send information to the cloud server regarding the status of the apparatus.

In accordance with another disclosed aspect there is provided a method for loading a plurality of articles. The method involves a loading step and a raising step. The loading step involves loading one or more articles on a first shelf of a multi-shelf storage apparatus mentioned above. The raising step involves raising the first shelf by supplying power, by a towing device, to the actuator of the apparatus, driving the lift mechanism. The method also includes repeating from the loading step with a subsequent shelf of the apparatus. The method may also include loading one or more articles on a first shelf of a subsequent apparatus connected to the first apparatus, raising the first shelf of the subsequent apparatus by supplying power, by a towing device through the apparatus, to the actuator of the subsequent apparatus, driving the lift mechanism of the subsequent apparatus, and repeating from the loading step with a subsequent shelf of the subsequent apparatus.

In accordance with yet another disclosed aspect there is provided a method for loading a plurality of articles. The method involves a loading step, an engaging step, a raising step, and a disengaging step. The loading step involves loading, by a manipulator of a robotic unit, one or more articles on a first shelf of a multi-shelf storage apparatus mentioned above. The engaging step involves engaging, by the robotic unit, a power supply interface of the robotic unit with the power interface of the apparatus. The raising step involves raising the first shelf by supplying power, by the robotic unit, to the actuator of the apparatus, driving the lift mechanism. The disengaging step involves disengaging the power supply interface from the power interface. The method also involves repeating from the loading step with a subsequent shelf of the apparatus.

In accordance with another disclosed aspect there is provided a method for unloading a plurality of articles. The method involves an unloading step and a lowering step. The unloading step involves unloading one or more articles from a last shelf of a multi-shelf storage apparatus mentioned above until the last shelf is empty. The lowering step involves lowering a subsequent shelf by supplying power, by a towing device, to the actuator of the apparatus, driving the lift mechanism. The method also involves repeating from the unloading step with the subsequent shelf of the apparatus. The method may also include unloading one or more articles from a last shelf of a subsequent apparatus connected to the first apparatus until the last shelf is empty, lowering a subsequent shelf of the subsequent apparatus by supplying power, by a towing device through the apparatus, to the actuator of the subsequent apparatus, driving the lift mechanism of the subsequent apparatus, and repeating from the unloading step with the subsequent shelf of the subsequent apparatus.

In accordance with yet another disclosed aspect there is provided a method for unloading a plurality of articles. The method involves an unloading step, an engaging step, a lowering step, and a disengaging step. The unloading step involves unloading one or more articles from a last shelf of a multi-shelf storage apparatus mentioned above until the last shelf is empty. The engaging step involves engaging, by the robotic unit, a power supply interface of the robotic unit with the power interface of the apparatus. The lowering step involves lowering a subsequent shelf by supplying power, by the robotic unit, to the actuator of the apparatus, driving the lift mechanism. The disengaging step involves disengaging the power supply interface from the power interface. The method also involves repeating from the unloading step with a subsequent shelf of the apparatus.

In accordance with another disclosed aspect there is provided a method for transporting a plurality of articles. The method includes a docking step, a towing step, and an undocking step. The docking step involves docking, by a towing device, to a lead apparatus of one or more apparatuses such as the apparatuses mentioned above. The towing step involves towing, by the towing device, the one or more apparatuses to a location. The undocking step involves causing, by a controller, a connection actuator of the one or more apparatuses to disengage a mechanical connection, thereby disconnecting all subsequent apparatuses from the towing device.

The location may be a first location, and the method may include towing, by the towing device, the one or more apparatuses to a second location and causing, by a controller, a connection actuator of the one or more apparatuses to disengage a mechanical connection, thereby disconnecting all subsequent apparatuses from the towing device. The method may also include unloading or loading one or more articles to the one or more apparatuses. The method may additionally include determining and recording, by a controller, locations of the one or more apparatuses, based on at least the location of causing the connection actuator to disengage. The method may then include reporting at least one of the location or status of one or more apparatuses to a cloud server. The method may then include determining, by the cloud server, that one of more apparatuses at a location should be moved based on receiving an indication and dispatching, by the cloud server, a towing device to the location by sending a signal to the towing device. Alternatively, the method may also include determining, by the cloud server, that one of more apparatuses at a location should be moved based on information stored on the cloud server and sending the signal to the towing device, by the cloud server, in response to the determination.

### BRIEF DESCRIPTION OF THE DRAWINGS

In the following, embodiments of the present disclosure will be described with reference to the appended drawings. However, various embodiments of the present disclosure are not limited to arrangements shown in the drawings.

FIG. 1 is a side view of a multi-shelf storage apparatus for storage of a plurality of articles;

FIG. 2 is a side view of an embodiment of a system for transporting a plurality of articles;

FIG. 3 is a side view of an alternative embodiment of a system for transporting a plurality of articles; and

FIG. 4 is a block diagram view of an example method for transporting a plurality of articles.

### DETAILED DESCRIPTION

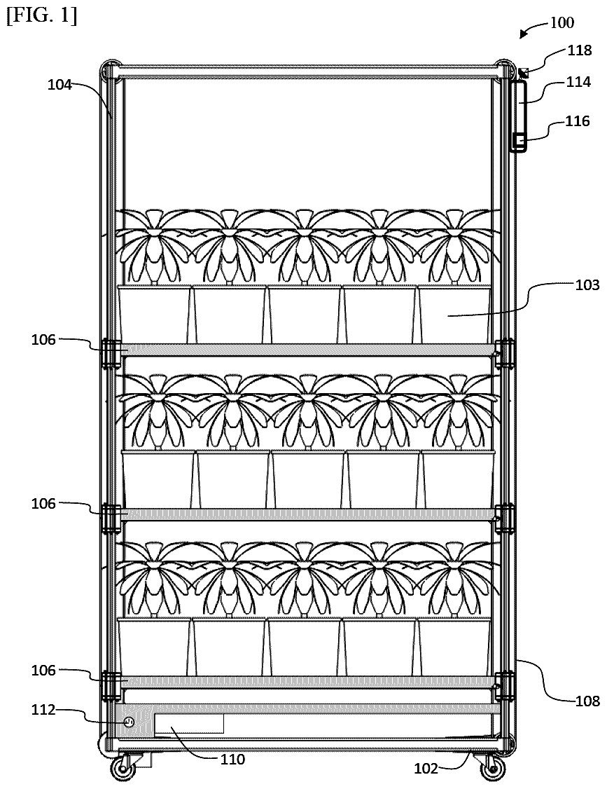

Referring to FIG. 1, an embodiment of an apparatus for storage of a plurality of articles is shown generally at 100. The apparatus 100 includes a wheeled base 102, and a 20 frame 104 disposed on the wheeled base 102. The apparatus 100 also includes a plurality of shelves 106 disposed on the frame 104, the shelves 106 generally vertically spaced and slidably movable along a generally vertical direction along the frame 104. The apparatus 100 also includes a lift mechanism 108 such as a belt or a chain connected to each of the plurality of shelves 106, such that movement of the drive mechanism 108 may cause the shelves 106 25 to collapse together or expand apart in a generally vertical direction. The drive mechanism 108 may be configured to move each shelf 106 independently, or may be configured to move the plurality of shelves 106 together. The apparatus 100 also includes an actuator 110 disposed on the frame 104, connected to the drive mechanism 108. When the actuator 110 is powered, it may cause the drive mechanism 108 to move, thereby causing the collapse or expansion of the shelves 106.

The apparatus 100 also includes a power interface 112 disposed on the frame and electrically connected to the actuator 110. The power interface 112 is configured to receive power from an external source and supply power to the actuator 110 so that it may drive the drive mechanism 108 and move the shelves 106. The power interface may be any sort of electrical connection, such as a standard electrical plug, or may be specifically adapted to facilitate powering the actuator. The power interface 112 may additionally include a mechanical interface, such as a towing connection, that allows an external apparatus to manipulate and move the apparatus 100. The power interface 112 may also have an alignment device including mechanical alignment systems such as rails or guides, or other alignment devices such as markers, transceivers, or lights to assist in autonomous navigation and connection, for example.

The apparatus 100 may have additional components. For example, apparatus 100 may include a controller 114 disposed on the frame 104. The controller 114 may be a computer system comprising a processing unit, a memory, and a power supply, for example. The controller 114 may also include a localization system 116 comprising one or more sensors or transceivers configured to facilitate locating the apparatus 100, such as GPS receivers for example. The controller 114 may additionally include a communication system 118 configured to send or receive signals such as a radio transmitter or a Wi-Fi transceiver, allowing the controller 114 to communicate with external devices such as a cloud server or devices on wireless network, for example. The controller 114 may also include a monitoring system (not shown) comprising one or more sensors configured to monitor the status of the apparatus 100, such as cameras disposed on each shelf 106 to monitor how full each shelf 106 is during the loading process, for example.

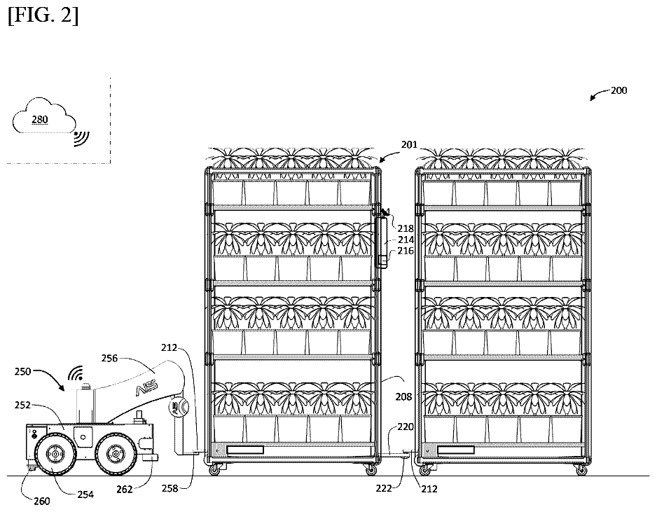

Referring now to FIG. 2, an embodiment of a system for transportation of a plurality of articles is shown generally at 200. The system 200 contains two apparatuses 201, which are variations of apparatus 100 of FIG. 1. Apparatuses 201 may include elements similar to those of apparatus 100, but within the respective 200 series of numbers, whether or not those elements are shown.

The system 200 also includes a towing device 250 configured to pull the apparatuses 201. In this exemplary embodiment, the towing device comprises a chassis 252 with a plurality of powered wheels 254. The towing device 250 also includes a towing hook 256 disposed on the chassis 252. The towing hook has a mechanical connection 258 for connecting to the lead apparatus 201. The towing hook 256 may be a robotic arm, and the arm may have an end effector which serves as the mechanical connection 258, for example. The mechanical connection 258 is also an electrical connection, connecting to power interface 212 of the lead apparatus 201. The electrical connection allows the towing device 250 to supply electrical power to the actuator 210 of the apparatus 201 such that the actuator 210 may drive the drive mechanism 208 to raise or lower shelves 206. The towing device 250 may also comprise a number of sensors, including a LiDAR 260 configured to detect obstacles and aid in the navigation of the towing device 250, and a rear-view camera 262 for aiding the device 250 in alignment when attempting to dock to apparatuses 201 by attaching the mechanical connection 258 for example.

Apparatuses 201 may include a second mechanical connection 220 for connecting to a subsequent apparatus 201. The second mechanical connection 220 may additionally be a second electrical connection, connecting to power interface 212 of the subsequent apparatus 201. The electrical connection may allow the towing device 250 to supply electrical power to the actuator 210 of the subsequent apparatus 201 through the first apparatus 201 such that the actuator 210 may drive the drive mechanism 208 to raise or lower shelves 206. The second mechanical connection 220 may also include a connection actuator 222. The connection actuator 222 may be operable to move a portion of mechanical connection 220, allowing for the automatic decoupling of the subsequent apparatus 201 from the first apparatus 201, for example.

The electrical connection 258 may transmit both power and signal from the towing device 250 to the apparatus and subsequent apparatuses 201. Furthermore, the electrical power and signal may be transmitted wirelessly, for example using WiFi connection for signal transmission and induction-based means for power transmission, or wired using conductive power and signal transmission means, or a combination of these means. In the case where a series of multiple apparatuses 201 are being towed by the towing device 250, the electrical connection may transmit a data packet stream to instruct which actuators 210 and 222 in which apparatus among the apparatuses 201 to be powered and controlled. For example, in case the towing device 250 is carrying 5 apparatuses 201, the towing device 250 may send an electrical signal to power the actuator 210 of the 3rd and 4th apparatuses or power the connection actuator 222 of the 3rd apparatus.

The system 200 may further include a server 280, which may be a cloud server as depicted in FIG. 2, or may be any other computer system such as a local server, for example. The server 280 may be in communication with the towing device 250, and/or controllers 214 of apparatuses 201, should they be present, through the communication system 218. The communication may take place through a centralized network such as a Wi-Fi network, or may use any other communication architecture such as an ad-hoc peer-to-peer system or systems formed between various devices, with one ultimately in communication with the server 280. Communication between the towing device 250, apparatuses 201, and the server 280 may serve a variety of purposes. For example, the towing device 250 may report its position to the server 280 when disengaging from apparatuses 201, thereby allowing the server 280 to track the position of apparatuses 201. Additionally, apparatuses 201 may use their localization system 216 on the controller 214 to determine their own location and communicate such information to the server 280 through communication system 218. The controller 214 may also report information such as status of the apparatus 201. With the accumulated information, the server 280 may also provide a variety of logistical, analytical, optimization, and forecasting services such as inventory management information (for example, how many articles are transported, where the articles are located, when they would be ready for shipment), optimizing the routing of towing devices 250 (for example, which towing device is closer to certain apparatuses and what is the optimal path from one location to a certain destination), or dispatching towing devices 250 in anticipation of the need arising, for example.

The towing device 250 may additionally include environmental sensors (not shown in figures) such as temperature, humidity, and CO₂ emission sensors disposed on the unit 250. The server 280, may receive such collected data alongside the corresponding coordinate position at which the data is collected by the unit 250 and create valuable information regarding the condition of the workspace such as a map of temperature and humidity within various positions in a greenhouse nursery.

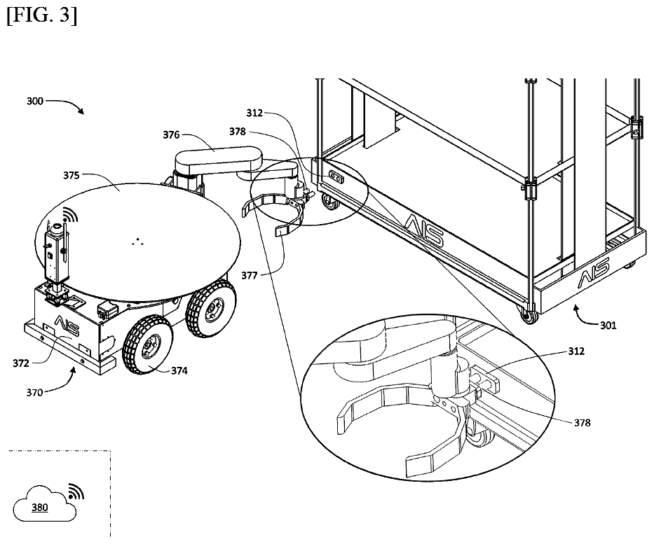

Referring now to FIG. 3, another embodiment of a system for storage of a plurality of articles is shown generally at 300. The system 300 contains an apparatus 301, which is a variation of apparatus 100 of FIG. 1. Apparatus 301 may include elements similar to those of apparatus 100, but within the respective 300 series of numbers, whether or not those elements are shown.

The system 300 also includes a robotic unit 370 configured to automatically load and unload articles to or from the apparatus 301. The robotic unit 370 comprises a base 372 comprising a plurality of powered wheels 374, and at least one robotic manipulator 376 disposed on the base 372. The manipulator 376 has an end effector 377, a mechanical gripper 10 for example, operably disposed on it, the end effector 377 configured to engage with articles to load or unload the articles to or from the apparatus 301. The robotic unit 370 also includes a power supply interface 378, shown in this case disposed on the robotic manipulator 376 facing the opposite direction as the end effector 377, complementary to the power interface 312 of apparatus 301. The power supply interface 378 allows the robotic unit 370 to supply electrical power to the actuator 310 of the apparatus 301 such that the actuator 310 may drive the drive mechanism 308 to raise or lower shelves 306. The robotic unit 370 may do this autonomously, during the process of loading or unloading the apparatus 301, by engaging the power supply interface 378 with the power interface 312 (as shown in the inset). This autonomous engagement may be facilitated by an alignment device on the power interface 312, which may be a sensory alignment device such as a marker light, or a mechanical alignment device such as guides, rails, or a specially-shaped socket to facilitate easy alignment, for example. The robotic unit 370 may also include a storage area 375, such as a table, for carrying articles to or from the apparatus 301 before or after loading or unloading, for example.

The system 300 may also optionally include a sewer 380, which may be a cloud server as depicted in FIG. 3, or may be any other computer system such as a local server, for example. The server 380 may be in communication with the robotic unit 370, and/or a controller of apparatus 301, should one be present, through a communication system. The communication may take place through a centralized network such as a Wi-Fi network, 30 or may use any other communication architecture such as an ad-hoc peer-to-peer system or systems formed between various devices, with one ultimately in communication the server 380. Communication between the robotic unit 370, apparatus 301, and the server 380 may serve a variety of purposes. For example, robotic unit 370 may report to the server 380 its capacity status or time spent when it is loading or unloading articles, or routing information when robotic unit 370 is autonomously navigating, for example. Additionally, apparatuses 301 may use their localization system on the controller to determine their own location and communicate such information to the server 380 through communication system. The controller may also report information such as status of the apparatus 301. With the accumulated information, the server 380 may also provide a variety of analytical, optimization, and forecasting services such as optimizing the routing of robotic units 370, or 10 dispatching robotic units 370 in anticipation of the need arising, for example.

With the accumulated information, the server 380 may also provide a variety of logistical, analytical, optimization, and forecasting services such as inventory management information (for example, how many articles are transported, where the articles are located, when would be ready for next transportation), optimizing the routing of robotic units 370, or dispatching robotic units 370 in anticipation of the need arising, for example.

The robotic unit 370 may additionally include environmental sensors (not shown in figures) such as temperature, humidity, and CO₂ emission sensors disposed on the unit 370. The server 380, may receive such collected data alongside the corresponding coordinate position at which the data is collected by the unit 370 and create valuable information regarding the condition of the workspace such as a map of temperature and humidity within various positions in the greenhouse nursery bay that the unit 370 is operating.

In the case where a towing device, such as the towing device 250 shown in FIG. 2, and the robotic unit 370 are used in collaboration with each other to transport articles in the apparatus 301, the server 380 may receive information related to the towing device 250 and optimize the collaboration among the towing device 250 and robotic units 370. For example, if a robotic unit 370 is loading articles to an apparatus 301, the server 380 may receive a signal from the robotic unit 370 or the apparatus 301 that the apparatus 301 is about to be filled with articles and ready for transportation, and then the server 380 may dispatch a towing device 250 to the location of the filling apparatus 301 for towing to a destination.

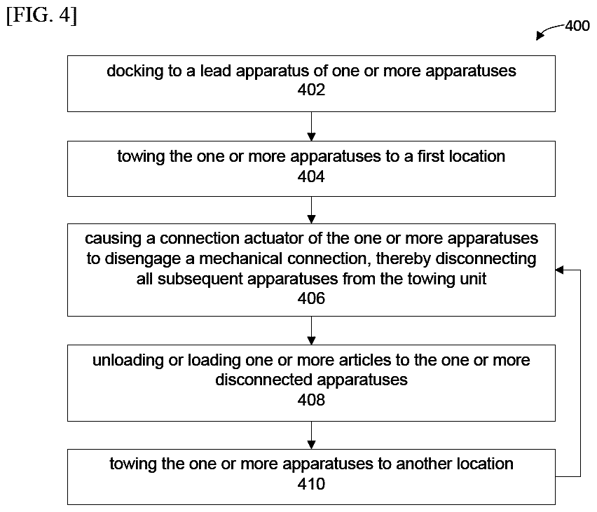

Referring to FIG. 4, an example of a method for transporting a plurality of articles is shown generally at 400. The method includes a docking step 402, followed by a towing step 404, a disconnecting step 406, a loading or unloading step 408, and then a second towing step 410. The docking step 402 involves docking, by a towing device such as docking unit 250 of FIG. 2, to a lead apparatus of one or more apparatus such as apparatus 100 of FIG. 1 or any similar apparatus such as apparatus 201 or 301. The towing step 404 involves towing, by the towing device, the one or more apparatuses from an initial location such as from a potting station where plants are potted then loaded onto the apparatuses, to a first location such as a growing field, for example. At the first location, the disconnecting step 406 involves causing, by a controller such as an onboard controller of the towing device 250 or a server such as cloud server 280 or 380 for example, a connection actuator of the one or more apparatuses to disengage a mechanical connection between two apparatuses, thereby disconnecting all subsequent apparatuses from the towing device. Alternatively, in other embodiments, the towing device 250 may disengage its mechanical connection 258 and leave all apparatuses at the first location.

In the loading or unloading step, articles may be loaded or unloaded to or from the one or more apparatuses. In one example, articles may be unloaded from the apparatus by a robotic unit, following a procedure including unloading, by a manipulator of a robotic unit, one or more articles from a last shelf of the apparatus until the last shelf is empty. The unloading procedure may then involve engaging, by the robotic unit, a power supply interface of the robotic unit with the power interface of the apparatus, and lowering a subsequent shelf by supplying power, by the robotic unit, to the actuator of the apparatus, driving the lift mechanism. The unloading procedure may then involve disengaging the power supply interface from the power interface, and repeating from the unloading step with the subsequent shelf of the apparatus which is now accessible. In yet other embodiments, the loading or unloading step may involve loading articles onto the apparatus, following a procedure including loading, by a manipulator of a robotic unit, one or more articles on a first shelf of an apparatus. The procedure may then include engaging, by the robotic unit, a power supply interface of the robotic unit with the power interface of the apparatus and raising the first shelf by supplying power, by the robotic unit, to the actuator of the apparatus, driving the lift mechanism. The procedure may then include disengaging the power supply interface from the power interface and repeating from the loading step with a subsequent shelf of the apparatus. The loading or unloading step may alternatively be done in other embodiments before the disconnecting step, and the supplying power step may be done by the towing device instead of the robotic unit, for example. In the disclosed method, it is contemplated that towing device and the robotic unit(s) may be different units or they may be the same unit. In other words, the docking and various towing steps could be performed by one or more towing devices, while the loading/unloading steps are performed by one or more robotic units, or alternatively, some or all of these steps could be performed by the same robotic unit.

The method then includes a second towing step 410 which involves towing, by the towing device, the one or more remaining apparatuses to a second location, and repeating from the disconnecting step. In other embodiments, the second towing step 410 may involve the towing device engaging with the one or more apparatuses at the first location following a step similar to docking step 402, then towing, by the towing device, the one or more apparatuses to a second location.

While specific embodiments have been described and illustrated, such embodiments should be considered illustrative of the invention only and not as limiting the invention as construed in accordance with the accompanying claims.

1-31. (canceled)

32. A multi-shelf apparatus for storage of articles, the apparatus comprising:
a wheeled base;
a frame disposed on the wheeled base;
a plurality of shelves disposed vertically spaced in the frame, the plurality of shelves being configured to provide a storage area for the articles, each shelf of the plurality of shelves being configured to move in a vertical direction relative to the frame;
a lift mechanism disposed on the frame and coupled to the plurality of shelves, the lift mechanism being operable to cause the shelves to collapse or extend in the vertical direction;
an actuator disposed on the frame, the actuator being configured to drive the lift mechanism;
a first power interface configured to receive electrical power, the first power interface being disposed on the frame and electrically connected to the actuator for supplying electrical power to the actuator; and
a first mechanical connection for connecting the apparatus to a towing vehicle, the first mechanical connection including an electrical connection for supplying electrical power from an external source of the towing vehicle to the first power interface.

33. The apparatus of claim 32, wherein the apparatus comprises a lead apparatus and further comprising a subsequent towed apparatus connected via a second mechanical connection to the lead apparatus, the lead apparatus comprising a second power interface configured to supply electrical power via the lead apparatus, and through the second mechanical connection to the subsequent towed apparatus.

34. The apparatus of claim 33, wherein the first mechanical connection comprises a passive mechanical connection configured to receive a complementary mechanical connection, and the second mechanical connection is configured to engage with a complementary mechanical connection of the subsequent towed apparatus.

35. The apparatus of claim 34, wherein the second mechanical connection comprises a connection actuator operable to engage or disengage with the complementary mechanical connection of the subsequent towed apparatus.

36. The apparatus of claim 35, wherein the connection actuator is electrically connected to the first power interface such that the connection actuator receives electrical power from the towing vehicle.

37. The apparatus of claim 32, wherein the first power interface comprises an alignment device configured to facilitate electrically connecting to a power supply interface of a robotic unit for receiving electrical power from the robotic unit.

38. The apparatus of claim 37, further comprising a controller disposed on the frame, the controller comprising at least a processing unit, a memory, and a power supply, wherein the controller is configured to control operation of at least one of the actuator configured to drive the lift mechanism and the connection actuator.

39. The apparatus of claim 38, wherein the controller further comprises a localization system comprising one or more sensors or transceivers configured to facilitate locating the apparatus.

40. The apparatus of claim 38, wherein the controller further comprises a monitoring system comprising one or more sensors configured to monitor a status of the apparatus.

41. A system comprising the apparatus of claim 37 and further comprising a robotic unit configured to automatically load or unload articles to or from the plurality of shelves, the robotic unit comprising:
a base comprising a plurality of powered wheels;
at least one robotic manipulator disposed on the base;
a loading or unloading end effector operably disposed on the at least one robotic manipulator and configured to engage with articles to load or unload articles to or from the plurality of shelves; and
a power supply interface complementary to the power interface of the multi-shelf apparatus, the power supply interface being operable to provide electrical power to drive the actuator of the multi shelf apparatus to cause the lift mechanism to raise and lower the shelves.

42. A system comprising the apparatus of claim 35 and further comprising a controller disposed on at least one of the towing device, the robotic unit, the lead apparatus, or the towed apparatus, the controller being operably configured to control operation of at least one of the actuator configured to drive the lift mechanism or the connection actuator.

43. The apparatus of claim 42, wherein the controller is configured to cause the connection actuator of the lead apparatus to automatically disconnect the subsequent towed apparatus.

44. The system of claim 42 further comprising a cloud server configured to communicate with the controller.

45. The system of claim 44, wherein the controller is disposed on the towing vehicle and the controller is operably configured to send information to the cloud server regarding the location of the lead apparatus or the towed apparatus.

46. The system of claim 41, wherein the robotic unit comprises a controller configured to monitor a status of the lead apparatus or towed apparatus and to send information to a cloud server regarding the status of the one or more apparatuses.

47. A method for loading a plurality of articles onto a plurality of shelves disposed vertically spaced in a frame, each shelf of the plurality of shelves being coupled to a lift mechanism driven by an actuator for moving the shelf in a vertical direction relative to the frame, the method comprising:
loading one or more articles onto a first shelf of the plurality of shelves;
connecting the frame to a towing vehicle via a first mechanical connection;
supplying electrical power from an external source of the towing vehicle via the first mechanical connection to a first power interface disposed on the frame, the first power interface being connected to supply electrical power to the actuator to cause the first shelf to be raised;
repeating said loading for subsequent shelves in the plurality of shelves.

48. The method of claim 47, wherein the frame comprises a first frame and further comprising a second frame connected to the first frame, the plurality of shelves being disposed on one of the first frame and the second frame, the second frame including a lift mechanism driven by an actuator, the method comprising:
supplying electrical power from the first power interface on the first frame via the second mechanical connection to a second power interface disposed on the second frame, the second power interface being connected to supply electrical power to the actuator on the second frame;
repeating said loading for subsequent shelves of the plurality of shelves disposed on the second frame.

49. The method of claim 47, further comprising:
unloading articles from a bottom shelf of the plurality of shelves until the bottom shelf is empty;
supplying electrical power from the external source via the first mechanical connection to the first power interface to supply electrical power to the actuator to cause a subsequent shelf of the plurality of shelves to be lowered;
repeating said unloading for each subsequent shelf of the plurality of shelves.

50. The method of claim 49, wherein the frame comprises a first frame and further comprising a second frame, the plurality of shelves being disposed on one of the first frame and the second frame, the second frame including a lift mechanism driven by an actuator, the method comprising:
unloading articles from a bottom shelf of the plurality of shelves on the second frame until the bottom shelf is empty;
connecting the second frame to the first frame via a second mechanical connection;
supplying electrical power from the external source via the first mechanical connection, the first power interface of the first frame, the second mechanical connection, and a second power interface of the second frame to the actuator of the second frame for driving the lift mechanism of the second frame to cause a subsequent shelf to be lowered;
repeating said unloading for each subsequent shelf of the plurality of shelves on the second frame.

51. The method of claim 47 wherein the frame comprises a first frame and further comprising one or more subsequent frames each connected to the first frame via a connection actuator providing a mechanical connection between the frames, each of the first and subsequent frames comprising a wheeled base, the plurality of shelves being disposed on one of the first frame and the subsequent frames, the method further comprising:
docking a towing vehicle to the first frame;
towing the first frame and the subsequent frames to a location; and
causing one of the connection actuators associated with one of the subsequent frames to disengage the mechanical connection thereby disconnecting all subsequent frames from the towing vehicle.

52. The method of claim 51, wherein the location comprises a first location, the method further comprising:
towing the first frame and any remaining subsequent frames to a second location; and
causing one of the connection actuators associated with one of the subsequent frames to disengage the mechanical connection, thereby disconnecting all subsequent frames from the towing vehicle.

53. The method of claim 51, further comprising determining and recording, by a controller, locations of the one or more apparatuses, based on at least the location of causing the connection actuator to disengage.

54. The method of claim 51, further comprising reporting at least one of the location or status of one or more apparatuses to a cloud server.

55. The method of claim 54, further comprising:
determining, by the cloud server, that one of more apparatuses at a location should be moved based on receiving an indication; and
dispatching, by the cloud server, a towing vehicle to the location by sending a signal to the towing vehicle.

56. The method of claim 54, further comprising:
determining, by the cloud server, that one of more apparatuses at a location should be moved based on information stored on the cloud server; and
sending the signal to the towing vehicle, by the cloud server, in response to the determination.

57. A method for loading a plurality of articles onto a plurality of shelves disposed vertically spaced in a frame, each shelf of the plurality of shelves being coupled to a lift mechanism driven by an actuator for moving the shelf in a vertical direction relative to the frame, the method comprising:
causing a manipulator of a robotic unit to load one or more articles onto a first shelf of the plurality of shelves;
aligning and engaging a power supply interface of the robotic unit with a power interface of the frame;
supplying power from the power supply interface of the robotic unit to the power interface of the frame to cause the actuator to raise the first shelf;
disengaging the power supply interface of the robotic unit from the power interface of the frame; and
repeating said loading for subsequent shelves in the plurality of shelves.

58. The method of claim 57 further comprising:
causing the manipulator of the robotic unit to unload articles from a bottom shelf of the plurality of shelves until the bottom shelf is empty;
aligning and engaging the power supply interface of the robotic unit with the power interface of the frame;
supplying power from the power supply interface of the robotic unit to the power interface of the frame to cause the actuator to lower a subsequent shelf of the plurality of shelves;
disengaging the power supply interface from the power interface; and
repeating said unloading for subsequent shelves of the plurality of shelves.
